(19) United States
(12) Patent Application Publication
(10) Pub. No.: US 2009/0183385 A1
(43) Pub. Date: Jul. 23, 2009

(54) CONTROLLING METHOD OF DRYER

(76) Inventors: Dong Geun Lee, Changwon-si (KR); Young Jin Doh, Jinhae-si (KR)

Correspondence Address: BIRCH STEWART KOLASCH & BIRCH, PO BOX 747, FALLS CHURCH, VA, 22040-0747, US

(21) Appl. No.: 12/297,599

(22) PCT Filed: Apr. 13, 2007
(86) PCT No.: PCT/KR07/01798

§ 371 Date: Apr. 10, 2009

(30) Foreign Application Priority Data
Apr. 13, 2006 (KR) 10-2006-0034272

(51) Int. Cl. F26B 3/02

(52) U.S. Cl. 34/497

(57) ABSTRACT

The present invention relates to a control method of a dryer that is capable of sensing whether a fire occurs inside the dryer and capable of extinguishing the fire. A control method of a dryer includes steps of: performing drying by using dry hot air; measuring temperature inside a drum during the step of performing drying by using dry hot air; and primarily and secondarily sensing whether a fire occurs inside the drum based on the sensed temperature.

### TECHNICAL FIELD

The present invention relates to a dryer. More specifically, the present invention relates to a control method of a dryer that is capable of sensing whether a fire occurs inside the dryer and capable of extinguishing the fire.

### BACKGROUND ART

Generally, laundry devices such as dryers are home appliances that are used to automatically dry damp laundry after washing. Dryers dry laundry by directly or indirectly heating laundry inside a drum, to evaporate moisture and exhaust the moisture outside the drum.

The drying method of directly heating laundry may cause severe deformation of laundry. As a result, it is a common drying method of drying is that the temperature inside the drum is heightened or air is heated by a heater to produce hot air and the hot air is drawn into the drum to dry laundry.

In a dryer that dries laundry by using hot air, external air is forcibly drawn into a drum by a fan and a heater installed outside the drum to be heated and the heated hot air is exhausted inside the drum to dry laundry.

The dryers are typically categorized based on a processing method of damp air produced when drying laundry, into an air exhaustion-type dryer and an air condensation-type dryer based on a drying method.

In the air exhaustion-type dryer, external air is drawn to produce hot air and damp air inside a drum is exhausted outside. In the air condensation-type dryer, air inside a drum is circulated to dry laundry without drawing external air. thus, damp air exhausted from the drum is condensed to remove moisture from the damp air and dry air is produces. The dry air is heated to be drawn into the drum.

On the other hand dryers may be categorized based on a method for performing a drying time and drying course into a manual drying-type and an automatic drying-type. In the manual drying-type dryer, a user selects a drying course as he/she wants and presets a corresponding drying time based on the laundry amount to perform drying. While, in the automatic drying-type dryer, a lower temperature sensor and a high temperature sensor sense the temperature of air that is flowing inside a drum during the drying course and drying is performed based on the sensed temperature.

### DISCLOSURE OF INVENTION

### Technical Problem

However, the above conventional dryer has disadvantages as follows.

In the dryer that heats air by using the high temperature heater, the heater might be overheated or the laundry might be heated higher than an ignition point of fabric by the overheated air. also, dust or lint that might be produced during the drying may contact with the high temperature heater to cause a fire. According to the conventional dryer, if a fire occurs inside the drum, there is no way to sense the fire. As a result, damage to fabric and the dryer can be completely destroyed by the fire, which might result in burning down the whole building.

### Technical Solution

To solve the problems, the present invention is to provide a control method of a dryer that is capable of sensing whether a fire occurs inside the dryer and capable of extinguishing the fire.

To achieve these objects and other advantages and in accordance with the purpose of the invention, as embodied and broadly described herein, a control method of a dryer includes steps of: performing drying by using dry hot air; measuring temperature inside a drum during the step of performing drying by using dry hot air; and primarily and secondarily sensing whether a fire occurs inside the drum based on the sensed temperature.

Here, it is preferred that the temperature is sensed adjacent to an air outlet through which air is exhausted from the drum in the step of measuring temperature inside a drum.

The step of primarily and secondarily sensing whether a fire occurs inside the drum based on the sensed temperature may include a step of comparing the sensed temperature inside the drum with a first predetermined temperature and primarily determining whether a fire occurs inside the drum.

If the sensed temperature inside the drum is higher than the first predetermined temperature, the control method of the dryer may further include steps of: stopping a motor and a heater; and notifying a user that a fire occurs inside the drum. If the sensed temperature inside the drum is below the first predetermined temperature, the control method of the dryer may further includes a step of: comparing the sensed temperature inside the drum with a second predetermined temperature and secondarily determining whether a fire occurs inside the drum.

It is preferred that the second predetermined temperature is substantially lower than the first predetermined temperature.

If the sensed temperature inside the drum is higher than the second predetermined temperature, the control method of the dryer may further include steps of: operating a motor and stopping a heater; and notifying a user that the temperature inside the drum is abnormally high.

After the step of notifying a user that the temperature inside the drum is abnormally high, the control method of the dryer may further include a step of stopping an operation of the dryer based on whether the user selects to stop the dryer. The step of sensing temperature inside a drum may be re-performed if the user does not select to stop the dryer.

The step of performing drying by using dry hot air is re-performed, if the sensed temperature inside the drum is below the second predetermined temperature.

### Advantageous Effects

The present invention has following advantageous effects.

In the dryer according to the present invention, the sensors adjacent to the air outlet through air inside the drum is exhausted to the duct may sense the temperature inside the drum. Hence, the sensed temperature is compared with the predetermined temperatures to sense a danger of fires and thus the heater as well as motor is controlled accordingly, which results in minimizing damage of a fire.

### BRIEF DESCRIPTION OF THE DRAWINGS

The accompanying drawings, which are included to provide further understanding of the disclosure and are incorporated in and constitute a part of this application, illustrate embodiments of the disclosure and together with the description serve to explain the principle of the disclosure.

In the drawings:

FIG. 1 is a longitudinal sectional view illustrating a dryer according to a preferred embodiment; and

FIG. 2 is a flow chart illustrating a control method of the dryer according to the embodiment shown in FIG. 1.

### BEST MODE FOR CARRYING OUT THE INVENTION

Reference will now be made in detail to the specific embodiments of the present invention, examples of which are illustrated in the accompanying drawings. Wherever possible, the same reference numbers will be used throughout the drawings to refer to the same or like parts.

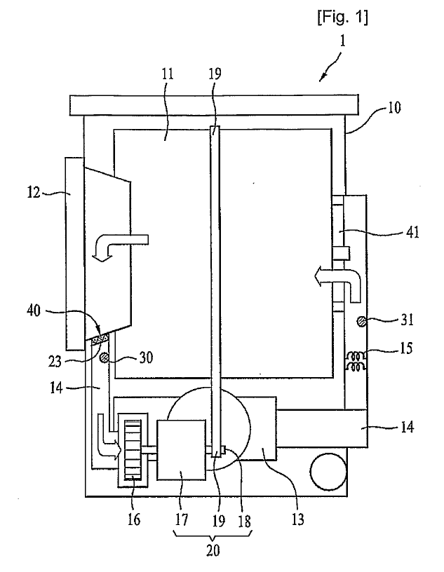

FIG. 1 is a longitudinally sectional view illustrating a dryer according to a preferred embodiment. First of all, in reference to FIG. 1, the dryer according to the preferred embodiment will be explained

The dryer 1 according to this embodiment includes a body 10, a drum 11 and a heater 5. the body 10 defines an exterior of the dryer. The drum 11 is mounted within the body 10. the heater 15 heats air that is supplied into the drum 11.

A door 12 is formed on a front of the body 10. the configurations of the dryer 1 are provided inside the body 10 and they are protected from external environments.

Laundry is introduced to the drum 11 and the drum 11 forms space for drying laundry therein. Thus, the laundry contacts with hot air inside the drum 11. the drum 11 includes an air suction opening (hereinafter, an air inlet 41) through which air is drawn from a duct 14, and an air exhaustion opening (hereinafter, an air outlet 40) through which internal air of the drum 11 is exhausted to the duct 14.

Here, the drum 11 may be movable or fixed If the drum is fixed an auxiliary structure on which the laundry is unfoldedly hung may be provided within the drum 11 to allow the laundry to contact with hot air. if the drum 11 is movable, the drum 11 may be rotated by a driving part 20.

The driving part 20 for rotating the drum 11 includes a motor 17 and a motor belt 19. the motor belt 19 is connected to a motor pulley 18 connected to the motor and it winds around an outer circumferential surface of the drum 11. as a result, the motor 17 rotates to rotate the motor pulley 18 and thus, the motor belt 19 wound around the motor pulley 18 rotates to rotate the drum 11.

As shown in FIG. 1, the drum 11 is rotatable within the body 10 and plural of lifters (not shown) are projected from an inner circumferential surface of the drum 11. the driving part 20 that supplies a rotational force to the drum 11 is connected to the drum 11. when the drum 11 is rotated by the operation of the driving part 20, the laundry is rotated inside the drum 11 by the lifters (not shown) and the laundry is mixed with hot air.

The duct 14 forms an air path within the body 10, the duct 14 is connected between the air outlet 40 and the air inlet 41, such that air exhausted from the drum 11 is re-drawn into the drum 11 through the duct 14.

For that, a ventilation part 16 is provided inside the duct 14 or near the drum 14 to allow air to flow smoothly through the duct 14 and to adjust a direction of air flow as well as strength of air flow. It is preferred that the ventilation part 16 is provided in the rear of the air outlet 41.

The heater 15 is provided in the duct 14 to heat the air drawn to the drum 11, such that hot air is produced.

A filter 23 is provided at the air outlet 40 to filter foreign substances having a relatively large size than predetermined from the air exhausted from the drum 11. as the filtered air passes the filter 23, the air without foreign substances is re-heated by the heater 15 and thus the hot air is re-supplied to the drum 11.

On the other hands temperature sensors 30 and 31 sense the temperature of air that is flowing inside the drum 11. here, the temperature sensors 30 and 31 are formed of a low temperature sensor 30 and a high temperature sensor 31. The low temperature sensor 30 is sensitive to relatively low temperatures and the high temperature sensor 31 is sensitive to relatively high temperatures. Specifically, the low temperature sensor 30 has good reactivity at approximately 70±30° C. and the high temperature sensor 31 has good reactivity at approximately 120±30° C.

The low temperature sensor 30 is sensitive to the relatively high temperatures and it is preferred that the lower temperature sensor 30 is provided at a predetermined portion having the lowest temperature inside the drum 11. for example, as shown in FIG. 1, the low temperature sensor 31 may be provided adjacent to the air outlet 40 through which the air inside the drum 11 is exhausted to the duct 14. especially, this embodiment presents that the low temperature sensor 30 is provided adjacent to the filter 23 provided at the air outlet 40.

The high temperature sensor 31 is sensitive to the relatively high temperatures and it is preferred that the high temperature sensor 31 is provided at a predetermined portion having the highest temperature inside the drum 11. for example, the high temperature sensor 31 is provided adjacent to the air inlet 41. hence, the high temperature sensor 31 senses the temperature of the air drawn into the drum 11 through the air inlet 41 and it transmits the sensed temperature to a micom (not shown). The micom (not shown) controls the heater 15 to control the temperature of air supplied to the drum 11.

The low temperature sensor 30 senses the temperature of air exhausted from the drum 11 to sense whether a fire occurs in the drum 11, which will be explained later.

A control panel (not shown) receives a command from a user to start or stop drying and transmits the command to the micom (not shown).

The micom (not shown) controls the dryer 1 to operate based on the sensed temperature. As mentioned above, the heater 15 is controlled to operate based on the air temperature sensed by the high temperature sensor 31. It is sensed whether a fire occurs inside the drum 11 based on the air temperature sensed by the low temperature sensor 30 to control an operation of the dryer.

Especially, it is primarily and secondarily sensed whether a fire occurs inside the drum 11 by using the temperature of air sensed by the low temperature sensor 30, which will be explained in detail later.

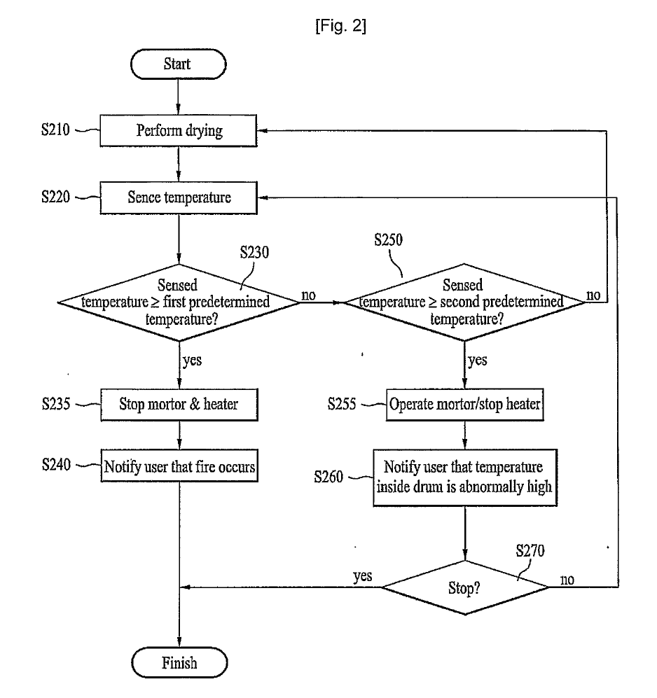

FIG. 2 is a flow chart illustrating a control method of a dryer by sensing whether a fire occurs in a drum according to the present invention.

First, a user loads damp laundry into the drum 11 and starts drying. Hence, drying starts by using hot air (S210).

Here, drying is performed as follows. If drying starts, the micom (not shown) operates the motor 17 to rotate the ventilation part 16 and the drum 11, and operates the heater 15 as well. Hence, air is flowing through the duct 14 and the air flowing along the duct 14 is heated by the heater 15 to be drawn into the drum 11. The high temperature hot air drawn into the drum 11 is mixed with the laundry and the air is exhausted through the air outlet 40. the exhausted hot damp air passes a condensation 13. hence, it is heat-exchanged and condensed to be dried the dry air is re-heated by the heater 15 and it is draw into the drum 11.

After drying, the temperature inside the drum 11 is sensed by the low temperature sensor 30 (S220). Specifically, the low temperature sensor 30 senses the temperature inside the drum 11 in a predetermined time period after drying starts.

When the temperature inside the drum 11 is sensed a step of primarily and secondarily sensing whether a fire occurs inside the drum 11 based on the sensed temperature inside the drum 11 is performed.

Primarily, the sensed temperature inside the drum 11 is transmitted to the micom (not shown) to compare the sensed temperature with a first predetermined temperature. As the result of comparison, it is determined whether a fire occurs inside the drum 11 (S230).

More specifically, the micom (not shown) senses whether the sensed temperature inside the drum 11 is higher than the first predetermined temperature. The first predetermined temperature may be the temperature that can be sensed by the low temperature sensor 30 if a fire occurs inside the drum 11. for example, the first predetermined temperature may be predetermined at 100° C.

If the sensed temperature inside the drum 11 is higher than the first predetermined temperature, the micom (not shown) determines that a fire occurs within the drum 11 and the micom (not shown) stops the motor 17 and the heater 15 (S235). If a fire occurs inside the drum 11, the heater 15 is stopped to prevent the drum 11 from overheating. In addition, the motor 17 is stopped to stop air supply to the drum 11. according to the present invention, if a fire occurs inside the drum 11, the motor 17 is stopped and thus air is not supplied to the drum 11. As a result, it is possible to extinguish a fire even when a fire occurs.

Hence, the micom (not shown) notifies a user that a fire occurs inside the drum 11 (S240). As a result, the user recognizes that a fire occurs inside the drum 11 and he/she takes necessary steps.

By the way, if the sensed temperature inside the drum 11 is below the first predetermined temperature, the sensed temperature is re-compared with a second predetermined temperature to secondarily determine whether a fire occurs inside the drum 11 (S250).

Here, it is preferred that the second predetermined temperature is preset below the first predetermined temperature. That is, the second predetermined temperature may be preset at the temperature that can be sensed when the temperature inside the drum 11 is abnormally high with no fire, for example, approximately 75° C.

Thus, if the sensed temperature inside the drum 11 is higher than the second predetermined temperature, the micom (not shown) determines that the temperature inside the drum 11 is abnormally high and thus the micom (not shown) stops the heater 15 (S255). Specifically, if the sensed temperature inside the drum 11 is higher than the second predetermined temperature, the micom (not shown) determines that the temperature inside the drum 11 increases abnormally high in spite of no fire and the micom (not shown) stops the heater 15 to prevent the temperature inside the drum 11 from increasing further.

In this case, it is preferred that the motor 17 is continuously operated because it is determined that a fire has not occurred yet.

Hence, the micom (not shown) notifies the user that the temperature inside the drum 11 is abnormally high (S260).

The user recognizes this abnormally high temperature inside the drum 11 and he/she selectively stops the dryer (S270). If the user selects to stop the dryer completely, the motor 17 of the dryer is stopped to stop the operation of dryer. If the user selects not to stop the dryer in spite of his/her recognition of the abnormally high temperature inside the drum 11, the temperature inside the drum 11 is re-sensed (S220). These processes are repeatedly performed to sense whether a fire occurs inside the drum 11.

By the way, if the sensed temperature inside the drum 11 is below the second predetermined temperature, the micom (not shown) determines that no fire occurs and that the temperature inside the drum 11 is normal. Hence, the micom (no shown) controls to re-perform drying. These processes are repeatedly performed

Thus, according to the present invention, the temperature inside the drum 11 is sensed and the sensed temperature is compared with the first predetermined temperature to primarily sense whether a fire occurs inside the drum 11. if the sensed temperature is below the first predetermined temperature, the sensed temperature inside the drum 11 is compared with the second predetermined temperature to secondarily sense whether the temperature inside the drum 11 is abnormally high.

In addition, if the sensed temperature is higher than the second predetermined temperature, as mentioned above, the dryer is controlled to extinguish or prevent a fire.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

### INDUSTRIAL APPLICABILITY

In the conventional dryer that heats air by using the high temperature heater, fabric of laundry might be heated higher than an ignition point of fabric by the overheated heater and overheated air and also dirt or lint produced during the drying might contact with the heater, which might results in carbonization. Even if a fire occurs in the conventional dryer, the conventional dryer fails to sense that and thus there might be damage to the dryer.

However, in the dryer according to the present invention, the sensors adjacent to the air outlet through air inside the drum is exhausted to the duct may sense the temperature inside the drum. Hence, the sensed temperature is compared with the predetermined temperatures to sense a danger of fires and thus the heater as well as motor is controlled accordingly, which results in minimizing damage of a fire.

1. A control method of a dryer comprising steps of:
performing drying by using dry hot air;
measuring temperature inside a drum during the step of performing drying by using dry hot air; and
primarily and secondarily sensing whether a fire occurs inside the drum based on the sensed temperature.

2. The control method of the dryer as claimed in claim 1, wherein the temperature is sensed adjacent to an air outlet through which air is exhausted from the drum in the step of measuring temperature inside a drum.

3. The control method of the dryer as claimed in claim 1, wherein the step of primarily and secondarily sensing whether a fire occurs inside the drum based on the sensed temperature comprises a step of
comparing the sensed temperature inside the drum with a first predetermined temperature and primarily determining whether a fire occurs inside the drum.

4. The control method of the dryer as claimed in claim 3, if the sensed temperature inside the drum is higher than the first predetermined temperature, further comprising steps of:
stopping a motor and a heater; and
notifying a user that a fire occurs inside the drum.

5. The control method of the dryer as claimed in claim 3, if the sensed temperature inside the drum is below the first predetermined temperature, further comprising a step of:
comparing the sensed temperature inside the drum with a second predetermined temperature and secondarily determining whether a fire occurs inside the drum.

6. The control method of the dryer as claimed in claim 5, wherein the second predetermined temperature is substantially lower than the first predetermined temperature.

7. The control method of the dryer as claimed in claim 6, if the sensed temperature inside the drum is higher than the second predetermined temperature, further comprising steps of:
operating a motor and stopping a heater; and
notifying a user that the temperature inside the drum is abnormally high.

8. The control method of the dryer as claimed in claim 7, after the step of notifying a user that the temperature inside the drum is abnormally high, further comprising a step of:
stopping an operation of the dryer based on whether the user selects to stop the dryer.

9. The control method of the dryer as claimed in claim 8, wherein the step of sensing temperature inside a drum is re-performed if the user does not select to stop the dryer.

10. The control method of the dryer as claimed in claim 6, wherein the step of performing drying by using dry hot air is re-performed if the sensed temperature inside the drum is below the second predetermined temperature.
